(19) United States
(12) Patent Application Publication
(10) Pub. No.: US 2016/0288313 A1
(43) Pub. Date: Oct. 6, 2016

(54) MOISTURE-MANAGING GRIP SLEEVE

(71) Applicant: HIGH CEDAR ENTERPRISE CO., LTD., Taichung City (TW)

(72) Inventor: Yung-Han WANG, TAICHUNG CITY (TW)

(21) Appl. No.: 14/672,701

(22) Filed: Mar. 30, 2015

(51) Int. Cl. B25G 1/10

(52) U.S. Cl. CPC B25G 1/10

(57) ABSTRACT

A grip sleeve includes a base layer and a top layer provided on one side of the base layer. The top layer has a plurality of weep holes extending toward the base layer. When a user holds the grip sleeve at the top layer, the weep holes of the top layer guide the user's sweat and other moisture generated to the base layer for drainage or absorption.

### BACKGROUND OF THE INVENTION

1. Technical Field

The present invention relates to grip sleeves for grip portions of tools, and more particularly to a grip sleeve that facilitate moisture management.

2. Description of Related Art

Referring to FIG. 1, a conventional grip sleeve 1 configured to be mounted or wound around a grip portion of a bat, a racquet, a club, a fishing pole or the like comprises a base layer 10 and a top layer 20 provided on the base layer 10. The material of the base layer 10 may include but is not limited to felt, non-woven cloth, and woven cloth. The material of the top layer 20 is preliminarily but not limited to Polyurethane (PU).

As the material of the top layer 20 of the grip sleeve 1, PU is advantageous for having excellent properties that make it highly adhesive, highly tough, highly elastic, and proof against corrosion, wear and impact. However, when a user's hand has held a tool grip with the grip sleeve 1 for a period of time and sweated, since the top layer 20 of the grip sleeve 1 is typically not absorbent and incapable of draining the sweat to the base layer 10, the sweat tends to accumulated between the grip sleeve 1 and the user's palm. Over time, this may not only lead to uncomfortable using experience, but also make the top layer 20 prematurely hydrolyze or crack. Hence, the prior art needs to be improved.

### BRIEF SUMMARY OF THE INVENTION

In view of the shortcomings of the prior art and the significance of its improvement, it is the objective of the present invention to provide a moisture-managing grip sleeve.

For achieving the foregoing objective, the present invention provides a grip sleeve that comprises a base layer and a top layer provided on the base layer one side, the top layer having a plurality of weep holes extending toward the base layer, wherein the top layer is made of a material that includes silica gel.

Therein, the top layer is formed by a plurality of wall members that are adjacent to each other and arranged into an interlaced net or arranged into an array, and between each two said wall members one said weep hole is defined.

Therein, the base layer is made of a material that includes felt, non-woven cloth, or woven cloth.

Therein, the grip sleeve further comprises a graph layer located between the base layer and the top layer, and each said wall member of the top layer is deposited on one said wall member of the graph layer.

To sum up, the present invention has the following structural features. When a user holds the grip sleeve at the top layer, since the top layer is made of silica gel and configured to drain, the user's sweat can be drained. Preferably, the weep holes of the top layer further guide the sweat to the base layer for drainage or absorption. Preferably, the plural wall members of the top layer are adjacent to each other and arranged into an interlaced net or arranged into an array, so as to give the user's hand holding the grip sleeve at the top layer increased friction and touch, thereby providing anti-slip effects.

In addition, the provision of the graph layer further adds the grip sleeve with visual aesthetic feeling. After a process of sublimation or heat compression molding that creates various patterns, the grip sleeve may be endowed with unique identity and may reflect the personal style of the user, providing both practical and article benefits.

The disclosed moisture-managing grip sleeve and its intended effects will be detailed in the description given below.

### BRIEF DESCRIPTION OF THE DRAWINGS

FIG. 1 is a schematic structural drawing of a conventional grip sleeve.

FIG. 2 is a schematic drawing of a first application of a grip sleeve according to a first preferred embodiment of the present invention.

FIG. 3 is another schematic drawing of the first application of the grip sleeve according to the first preferred embodiment of the present invention.

FIG. 4 is a schematic drawing of a second application of the grip sleeve according to the first preferred embodiment of the present invention.

FIG. 5 is a schematic drawing of a grip sleeve according to a second preferred embodiment of the present invention.

FIG. 6 is another schematic drawing of the grip sleeve according to the second preferred embodiment of the present invention.

FIG. 7 is a schematic drawing of a grip sleeve according to a third preferred embodiment of the present invention.

FIG. 8 is a schematic drawing of the grip sleeve according to the fourth preferred embodiment of the present invention.

FIG. 9 is another schematic drawing of a grip sleeve according to a fourth preferred embodiment of the present invention.

FIG. 10 is a schematic drawing of a grip sleeve according to a fifth preferred embodiment of the present invention.

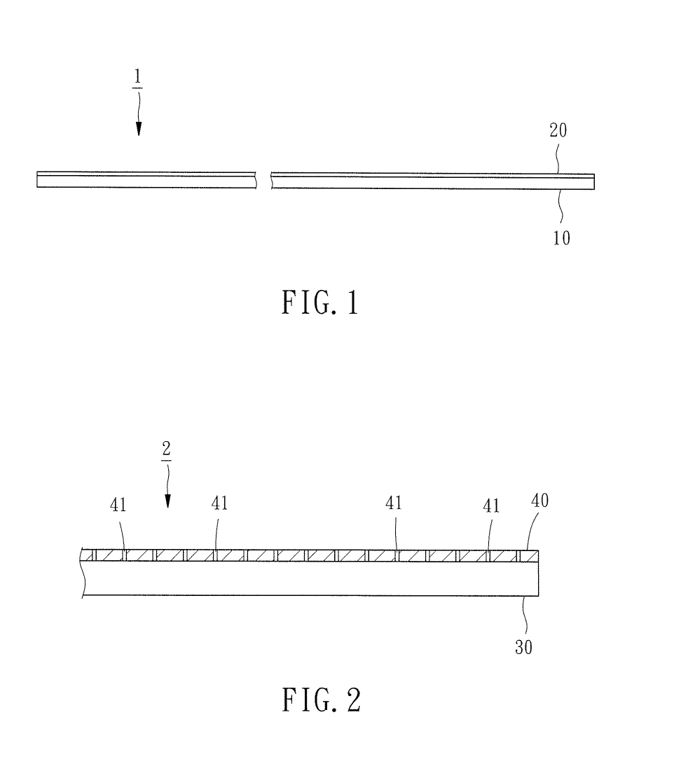

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale. Unless otherwise noted, like elements will be identified by identical numbers throughout all figures.

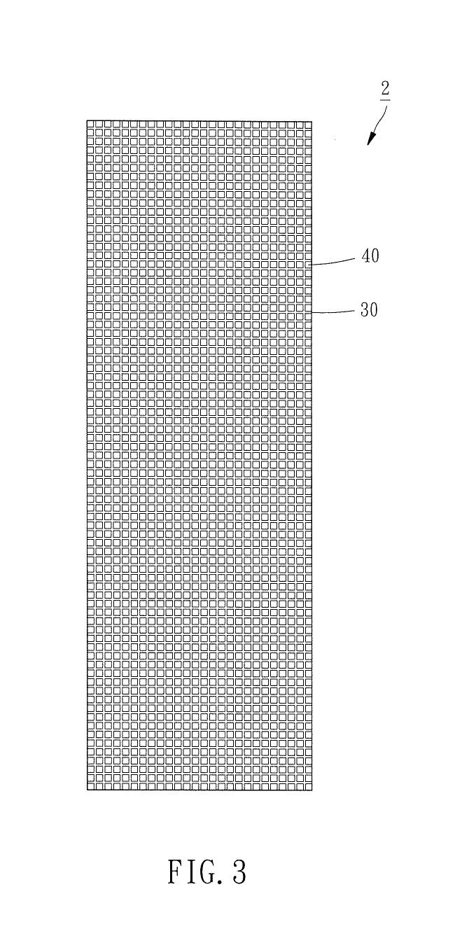

Referring to FIG. 2 and FIG. 3, in a preferred embodiment of the present invention, a moisture-managing grip sleeve 2 comprises a base layer 30 and a top layer 40.

The top layer 40 is stacked at one side of the base layer 30. The top layer 40 has at least one weep hole extending toward the base layer 30. In the first preferred embodiment of the present invention, the top layer 40 has plural said weep holes 41 that are arranged into an array.

Therein, the base layer 30 is mainly made of a material that includes felt, non-woven cloth, or woven cloth, but not limited thereto.

Therein, the top layer 40 the top layer is mainly made of a material that includes silica gel, but not limited thereto.

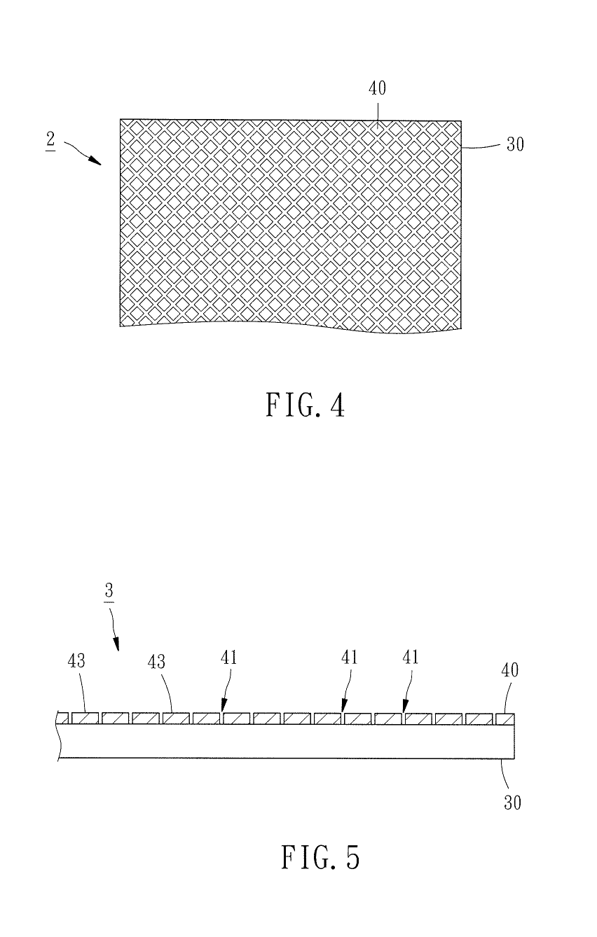

Referring also to FIG. 4, the plural weep holes 41 of the top layer 40 of the grip sleeve 2 may be alternatively arranged into an interlaced net.

While the above description is set forth for illustrating the structural features of the first preferred embodiment of the present invention, the following description will be directed to the structural features of a second preferred embodiment of the present invention.

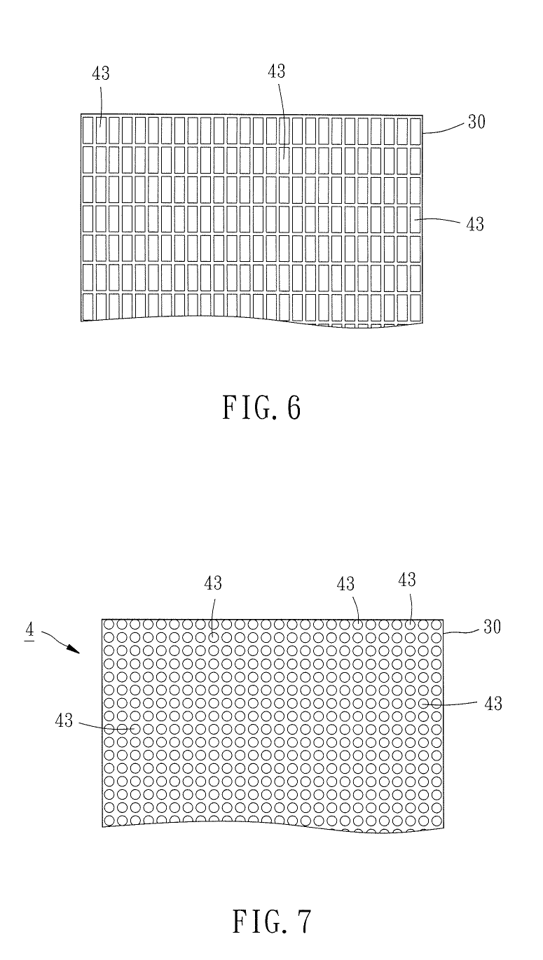

Referring to both FIG. 5 and FIG. 6, in the second preferred embodiment of the present invention, a moisture-managing grip sleeve 3 is similar to its counterpart as stated in the previous embodiment with the following differences.

Here, the top layer 40 is formed by a plurality of wall members 43 that are adjacent to each other. Between each two said wall members 43, one weep hole 41 is defined. Similarly, the plural weep holes 41 of the top layer 40 of the grip sleeve 2 are arranged into an array or an interlaced net.

While the above description is set forth for illustrating the structural features of the second preferred embodiment of the present invention, the following description will be directed to the structural features of a third preferred embodiment of the present invention.

Referring also to FIG. 7, in the third preferred embodiment of the present invention, a moisture-managing grip sleeve 4 is similar to its counterparts as stated in the previous embodiments with the following differences.

Here, the plural wall members 43 of the top layer 40 may each be round, angled, multidimensional, conical, cubic, arched, or concave, and the plural wall members 43 are each shaped as a round grain. Similarly, the top layer 40 is formed by the plural wall members 43 that are adjacent to each other, and one said weep hole 41 is defined between each two said wall members 43. They may be arranged into an array or arranged into an interlaced net.

To sum up, the disclosed grip sleeve has the following expected effects. When a user holds the grip sleeve at the top layer 40, since the top layer 40 is made of silica gel and configured to drain, the user's sweat can be drained. Preferably, the weep holes 41 of the top layer 40 further guide the sweat to the base layer 10 for drainage or absorption. Preferably, the plural wall members 43 of the top layer 40 are adjacent to each other and arranged into an interlaced net or arranged into an array, so as to give the user's hand holding the grip sleeve at the top layer 40 increased friction and touch, thereby providing anti-slip effects.

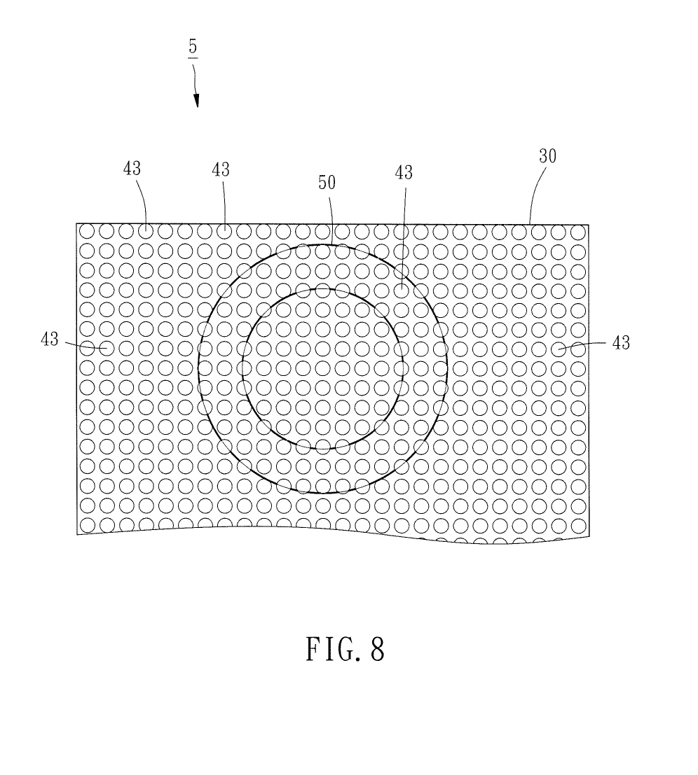

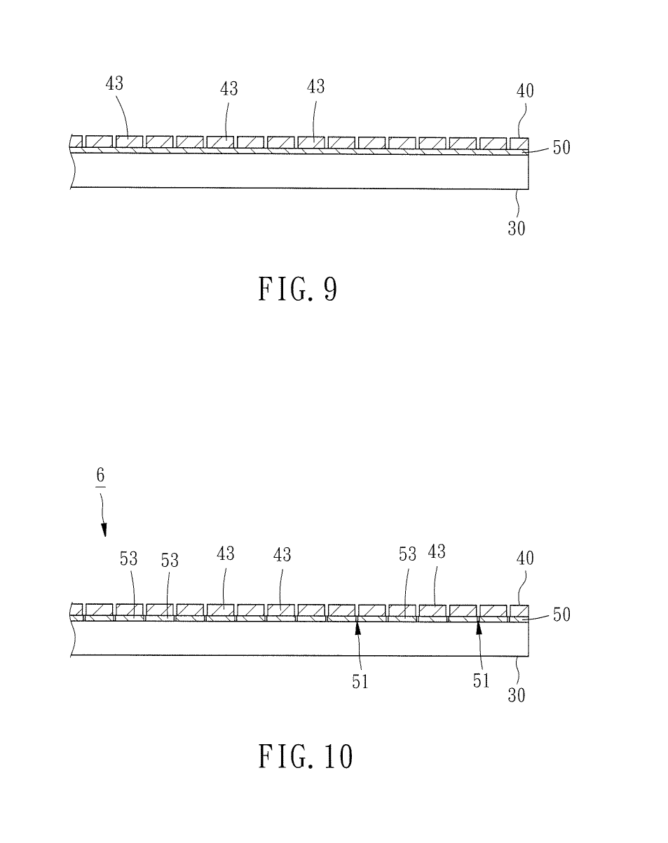

Referring also to FIG. 8 and FIG. 9, in a fourth preferred embodiment of the present invention, a moisture-managing grip sleeve 5 is similar to its counterparts as stated in the previous embodiments with the following differences.

A graph layer 50 is provided between the base layer 30 and the top layer 40. The graph layer 50 may be formed between the base layer 30 and the top layer 40 through a process that includes but is not limited to sublimation or heat compression molding.

In the fourth preferred embodiment of the present invention, the top layer 40 or the graph layer 50 may be transparent. Similarly, the plural wall members 43 of the top layer 40 are each shaped as a round grain.

While the above description is set forth for illustrating the structural features of the fourth preferred embodiment of the present invention, the following description will be directed to the structural features of a fifth preferred embodiment of the present invention.

Referring also to FIG. 10, in the fifth preferred embodiment of the present invention, a moisture-managing grip sleeve 6 is similar to its counterpart as stated in the previous embodiment with the following differences.

The graph layer 50 is formed by wall members 53 that are adjacent to each other. Between each two said wall members 53, one said weep hole 51 is defined.

Therein, each said wall member 43 of the top layer 40 is deposited on one said wall member 53 of the graph layer 50.

Therein, the weep holes 51 of the graph layer 50 have a diameter that is smaller than or equal to that of the weep holes 41 of the top layer 40.

To sum up, the disclosed grip sleeve has the following expected effects. The graph layer 50 may convey a design concept of designer or a user to endow the grip sleeve with improved visual aesthetic feeling. After a process of sublimation or heat compression molding that creates various patterns, the graph layer 50 can be well presented between the base layer 30 and the top layer 40. Thus, when held by a user, the grip sleeve can provide unique identity and reflect the personal style of the user, bringing about both practical and article benefits.

In addition, the graph layer 50 having the weep holes 51 also supports drainage of sweat as recited in the previous embodiments. The weep holes 51 of the top layer 50 allow a user's sweat to be guided to the base layer 10 for drainage or absorption, so as to achieve the expected effects and the objects of the present invention.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. A grip sleeve, comprising:
a base layer and a top layer provided on the base layer one side, the top layer having a plurality of weep gaps extending toward the base layer, wherein the top layer is made of a material that includes silica gel.

2. The grip sleeve of claim 1, wherein the top layer is formed by a plurality of wall members that are adjacent to each other and arranged into an array, and between each two said wall members one said weep gap is defined.

3. The grip sleeve of claim 1, wherein the top layer is formed by a plurality of wall members that are adjacent to each other and arranged into an interlaced net, and between each two said wall members one said weep gap is defined.

4. The grip sleeve of claim 2, wherein each of the wall members of the top layer is shaped as a round grain.

5. The grip sleeve of claim 3, wherein each of the wall members of the top layer is shaped as a round grain.

6. The grip sleeve of claim 1, wherein the base layer is made of a material that includes felt, non-woven cloth, or woven cloth.

7. The grip sleeve of claim 6, further comprising a graph layer located between the base layer and the top layer.

8. The grip sleeve of claim 2, wherein the base layer is made of a material that includes felt, non-woven cloth, or woven cloth.

9. The grip sleeve of claim 8, further comprising a graph layer located between the base layer and the top layer.

10. The grip sleeve of claim 3, wherein the base layer is made of a material that includes felt, non-woven cloth, or woven cloth.

11. The grip sleeve of claim 10, further comprising a graph layer located between the base layer and the top layer.

12. The grip sleeve of claim 1, further comprising a graph layer located between the base layer and the top layer.

13. The grip sleeve of claim 12, wherein the graph layer is formed by a plurality of wall members that are adjacent to each other, and between each two said wall members one said weep hole is defined.

14. The grip sleeve of claim 13, wherein each said wall member of the top layer is deposited on one said wall member of the graph layer.

15. The grip sleeve of claim 2, further comprising a graph layer located between the base layer and the top layer.

16. The grip sleeve of claim 15, wherein the graph layer is formed by a plurality of wall members that are adjacent to each other, and between each two said wall members one said weep hole is defined.

17. The grip sleeve of claim 16, wherein each said wall member of the top layer is deposited on one said wall member of the graph layer.

18. The grip sleeve of claim 3, further comprising a graph layer located between the base layer and the top layer.

19. The grip sleeve of claim 18, wherein the graph layer is formed by a plurality of wall members that are adjacent to each other, and between each two said wall members one said weep hole is defined.

20. The grip sleeve of claim 19, wherein each said wall member of the top layer is deposited on one said wall member of the graph layer.
